(19) United States
(12) Patent Application Publication
(10) Pub. No.: US 2022/0129854 A1
(43) Pub. Date: Apr. 28, 2022

(54) STANDARDIZED SKILL CREATION AND PUBLISHING

(71) Applicant: Western Governors University, Salt Lake City, UT (US)

(72) Inventors: Howard Wayne Skipper, Eugene, OR (US); Kacey Bliss Thorne, Pleasant Grove, UT (US); Darin Ray Hobbs, Murray, UT (US); Joann Lynn Rishel Kozyrev, Salt Lake City, UT (US); Marni E. Baker, Park City, UT (US); Allison Renee Blackwell, San Diego, CA (US); Samantha Marin Coen, Lutz, FL (US); Jerry Damon Jasperson, Heber City, UT (US)

(21) Appl. No.: 17/513,458

(22) Filed: Oct. 28, 2021

Related U.S. Application Data
(60) Provisional application No. 63/106,723, filed on Oct. 28, 2020.

(51) Int. Cl. G06Q 10/10

(52) U.S. Cl. CPC G06Q 10/103

(57) ABSTRACT

Transmitting digital definitions of skills at a computing system to allow the digital definitions skills to be interoperable with other computing systems. The method includes identifying a skill name for a skill. The method further includes contextualizing the skill name for a specific system or use case by creating and storing metadata associated with the skill name. The method further includes publishing the contextualized skill at a predetermined network location, in a standardized digital format allowing for interoperability with other computing systems, wherein publishing comprises providing an active network link to the contextualized skill.

### CROSS-REFERENCE TO RELATED APPLICATIONS

This application claims the benefit of and priority to U.S. Provisional Patent Application Ser. No. 63/106,723 filed on Oct. 28, 2020, and entitled “Standardized Skill Creation and Publishing,” and which application is expressly incorporated herein by reference in its entirety.

### BACKGROUND

### Background and Relevant Art

Computers and computing systems have affected nearly every aspect of modern living. Computers are generally involved in work, recreation, healthcare, transportation, entertainment, household management, etc.

Computers can be used to manage so called contextualized “skills”, where the skills have a descriptive name, and the descriptive skill name is contextualized by associating metadata with the skill name to create a definition of the skill in context to a specific organization or use case. The contextualized skill can be compared to contextualized skills for other organizations or use cases. Note that as used herein, unless otherwise indicated, a skill is a contextualized skill having a skill name and contextualization metadata.

For example, Skills Architects may work with thousands of records in a library of skills in the form of a spreadsheet. Spreadsheets are cumbersome and fragile for Skills Architects to use and, as the library expands, spreadsheets will soon prove inadequate to the task of managing the library. As used herein, a skills library, or library is a collection of RSDs.

The Skills Architects deliver collections of relevant skills to the teams that design programs and curricula at an institution. They currently do so by selecting skills and exporting them as a subset of the spreadsheet. This is a cumbersome manual process of searching and copying and introduces the likelihood that a program team will not be working with the very latest relevant skills as their collection is potentially obsolete the moment it is delivered.

The Skills Architects work with outside personnel to research, craft, and improve skills according to the needs of institution program design teams. The process of putting sets of new skills into the library is manual and subject to error. These skills are not useful to the program team without information about relevant industry and job keywords, relationships to relevant certifications and standards, a well-crafted contextualized skill statement, etc. The process of putting this additional data in place is similarly manual and error prone.

The growing skills library can be used for linking an institution's educational products to the needs of industry employers and the students they will employ. Thus, there is a desire to share skills outside of institutions, and to create relationships between skills, competencies, assessments, achievements, pathways, etc. The current method of managing skills affords none of this.

Sharing data is currently extremely difficult, and open-source skills management tools that meet these aims do not seem to exist.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that includes acts for transmitting digital definitions of skills at a computing system to allow the digital definitions skills to be interoperable with other computing systems. The method includes identifying a skill name for a skill. The method further includes contextualizing the skill name for a specific system or use case by creating and storing metadata associated with the skill name. The method further includes publishing the contextualized skill at a predetermined network location, in a standardized digital format allowing for interoperability with other computing systems, wherein publishing comprises providing an active network link to the contextualized skill.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a system where embodiments can be practiced;

FIG. 2 illustrates a user interface screen for creating and editing skills;

FIG. 3 illustrates a user interface screen for a skills library that allows a user to view a list of skills;

FIG. 4 illustrates a user interface screen showing a published skill;

FIG. 5 illustrates a user interface screen for a draft collection;

FIG. 6 illustrates a user interface screen for a published collection;

FIG. 7 illustrates a user interface screen for a set of collections; and

FIG. 8 illustrates a method for publishing skills.

### DETAILED DESCRIPTION

Embodiments may be included in a system to author and manage Rich Skill Definitions (RSDS) (sometimes referred to herein as contextualized skills) and facilitate publishing in common standard formats. An RSD is a contextualized skill statement and associated metadata that enables interoperability of skills. Some skill statements have three elements, including a subject, predicate, and object. For example, for the skill statement may be “The individual evaluates chemical processes to identify ways to optimize performance.” In this example, “the individual” is the subject, “evaluates” is the predicate, and “chemical processes to identify ways to optimize performance” is the object. The metadata for an RSD may be organized according to a predetermined schema. For example, the following illustrates an example schema:

| Property | Type | Comments/Example |
|---|---|---|
| UUID* | URI | http://ngp.wgu.edu/skills/000001 |
| Skill Name* | String | Short name or label for Skill, i.e. “Verbal |
| Contextualized | String | Skills description written in standard syntax |
| Skill Statement* | | |
| Skill Category | Array | Key term to categorically organize skills |
| Professional | Array | Field for associating skills to professional standards |
| Standard | | (i.e., NICE Framework) |
| Tools | Array | Hardware or software typically associated with a skill |
| Certifications | Array | Field for associating external certifications to RSDs |
| Occupation Data | Array | We need to develop a context object, which indicates |
| Categories | | skill alignment to relevant job roles/occupations. |
| (collapsed fields) | | BLS SOC: Major group, Industry, Occupation, Job |
| | | Function |
| | | O*Net: Job Role |
| Relationships | Array | Each relationship needs a Relationship type and GUID |
| | | of the linked data. Kinds of relationships may include: |
| | | Belongs to |
| | | Depends on |
| Specific Employer | Array | Field to relate RSDs to specific employers |
| Specific Employer: | Array | Field to relate job titles specific to RSDs for an |
| Job Title | | employer |
| Intelligent Source | Array | Source data to connect RSDs to intelligent job market |
| Data | | data and underlying unique identifiers (i.e., Emsi; |
| Creator* | String | Ex: WGU |

With respect to common standard formats, embodiment may receive and output data, for example, according to CASE data specification, CTDL-ASN data specification, Open Badges 2.x, etc.

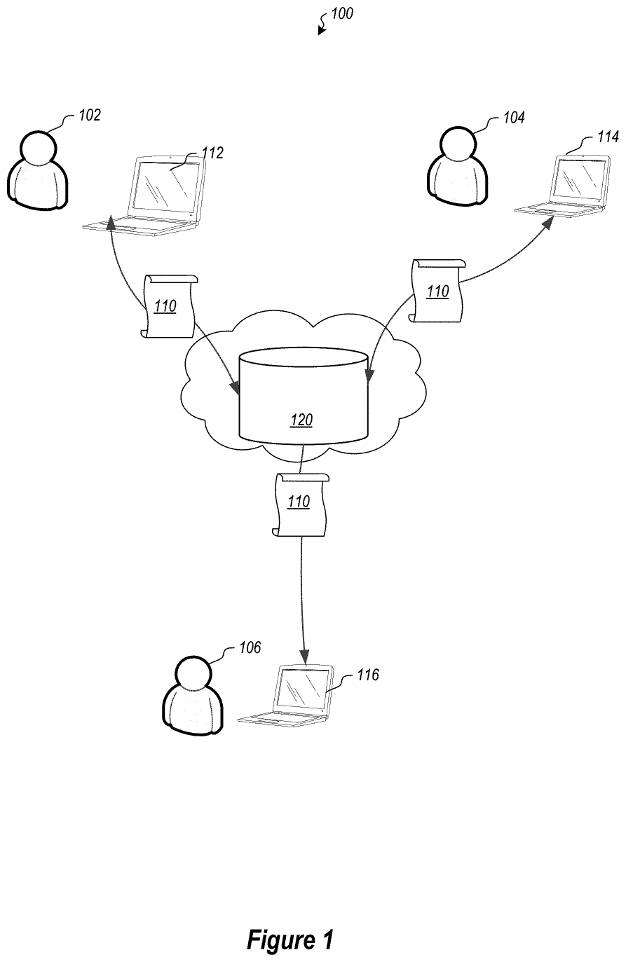

Referring now to FIG. 1, some embodiments may be a computer implemented system 100 configured to manage, process, and provide universal access through standardized data formats and universal resource locators (URLs) on computer networks, to large swaths of data and will help an institution contribute to an ecosystem of interoperability where one or more of the following may be implemented:
achievements are understood in terms of the skills they recognize
learners, educators, and employers can define stackable pathways through learning programs
verifiable learner records facilitate the efforts of candidates searching for jobs and employers vetting candidates for those jobs
computer interfaces are configured to make it is easy to see the landscape of skills in a particular domain and increase the use of common definitions that make achievements actionable
open standards ensure that many institutions and vendors may participate and use available data

By publishing the contextualized skills 110 from a data store 120 (such as a database, web server, or other storage) using URLs pointing to the data store 120, embodiments have a number of advantages. First, users are able to ensure that the skills are up to date for any user who wishes to access the contextualized skills, rather than simply having whatever context was provided when a particular contextualized skill was cut and pasted from a document or spreadsheet and sent to the user. Second, the user can browse and access skills from virtually any system or location. Third, users can add the URL's in their own creation of conceptualized skills to provide for linking between different skills for different organizations or use cases. Other advantages, illustrated herein exist as well. Thus, embodiments implement a technologically rooted solution to an Internet-centric problem.

A Note about Users

This document considers only three users of the system: the Skills Architect 102, who is the primary operator of the system; the program team members 104, who consume the work of the Skills Architect in the system by reviewing collections of skills; and external users 106 viewing skills and collections at public URLs pointing to a publicly available, network connected datastore 120, provided by the system. Note that these users accomplish these tasks by using respective computer systems 112, 114, and 116.

### Core Capabilities

Some embodiments include the following capabilities:

Work with Skills

To serve the program team and other consumers of skills, a Skills Architect is able to create, edit, and search for skills; add them to collections; view them; archive and unarchive them; and make them available to others.

In some embodiments, the work of the Skills Architect with subject matter experts (SMEs) is done outside the system, and the first time this data appears in the system will be when a Skills Architect begins entering skills manually, via batch import, or via other appropriate entry method.

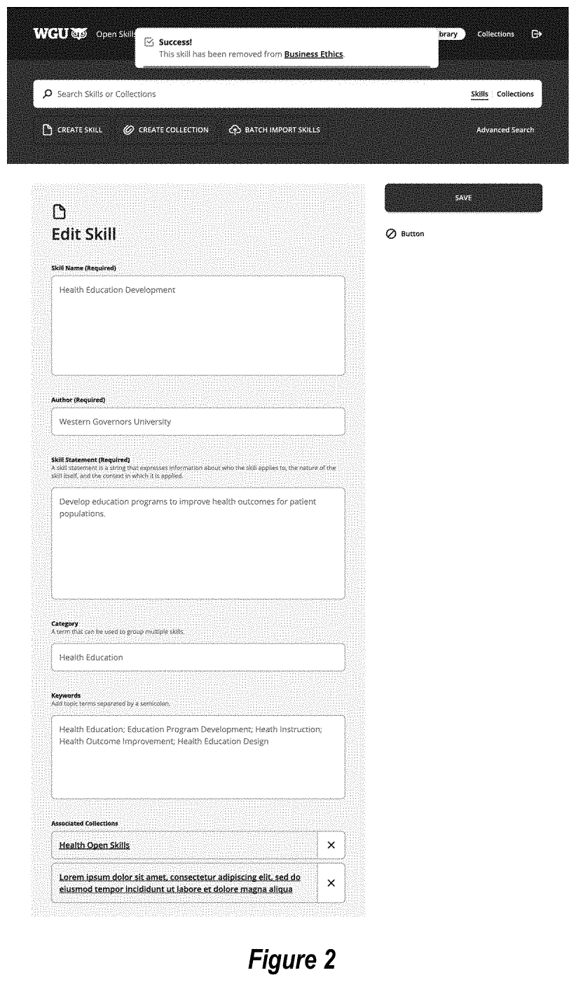

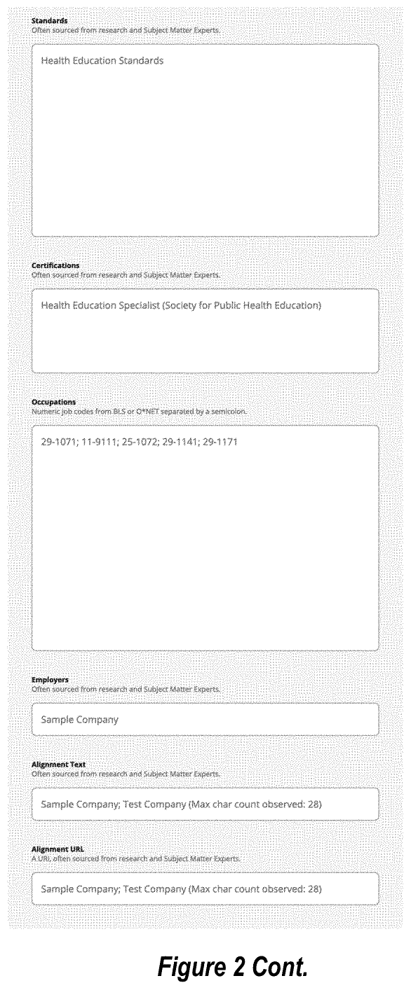

### Create Skill (See FIG. 2)

1. A Skills Architect 102 is able to use the user interface (which may be displayed at the computer system 112) to create a skill so that they may later use or improve it.
   » New skills start in “draft” status
2. A Skills Architect 102 is able to use the user interface to clone a skill so that they may create a derivative skill that is separate from the original.

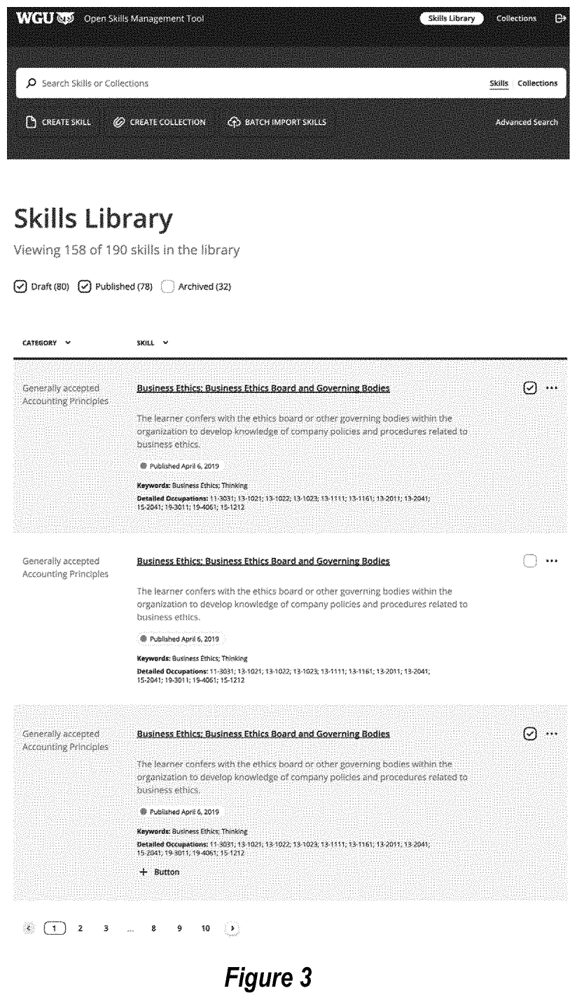

### Search/Read Skills (See FIG. 3)

3. A Skills Architect 102 is able to use the user interface to view the complete list of skills so that they can find something they are looking for.
4. A Skills Architect 102 is able to use the user interface to search the library for skill(s) so that they can determine which skill(s) to operate on next.
   » Any combination of parameters is fair game—draft or not, name, contextualized skill statement, keywords, job codes, standards, certifications, etc.
5. A Skills Architect 102 is able to use the user interface to search within a collection for skill(s) so that they can determine which skill(s) to operate on next.
6. A Skills Architect 102 is able to use the user interface to select a skill to view from a list and view it so that they can determine if it merits inclusion in a collection, needs further editing, etc.
7. A Skills Architect 102 is able to use the user interface to access a skill in the system by URL and view its details so that they can determine if it merits inclusion in a collection or needs further editing.
8. A non-Skills Architect (e.g., a team member 104 or external user 106) user is able to use another user interface (which may be displayed at computer system 114 or 116 respectively) to view a public view of a skill by URL so that they can use it in their work.
   » Note: only published skills may be viewed unauthenticated

### Update Skill (See FIG. 2)

9. A Skills Architect 102 is able to use the user interface to edit a skill so that they can correct errors, add SOC codes, add or change keywords, etc.

### Archive Skill

10. A Skills Architect 102 is able to use the user interface to archive a skill so it can no longer be put into collections.
11. A Skills Architect 102 is able to use the user interface to unarchive a skill so it can be put into collections again.

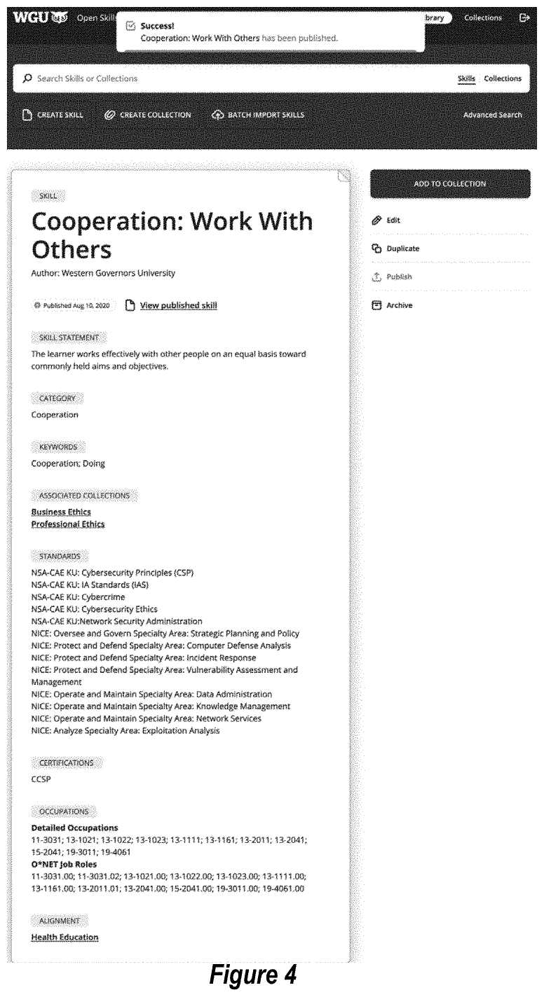

### Make a Skill Available to the Public (See FIG. 4)

12. A Skills Architect 102 is able to use the user interface to publish a skill, promoting it from “draft” status, so it can be viewed publicly and used in collections.
13. A Skills Architect 102 is able to use the user interface to be warned when attempting to take a skill out of “draft” that lacks useful data, such as SOC codes, so that they do not confuse the program team.

### Understand a Skill (See FIG. 4)

14. A Skills Architect 102 is able to use the user interface to know, when viewing a skill, which collections it is a part of so that they can understand the impact of potential edits.
15. A Skills Architect 102 is able to use the user interface to know, when viewing a skill, which other skills in the library have a similar skill statement so that they can consider consolidating these skills.
16. A Skills Architect 102 is able to use the user interface to see the history of changes to a skill so that they can determine where problems originated.
17. A Skills Architect 102 is able to use the user interface to see if a skill has a “draft” status or is published so that they can identify which skills require attention to finalize and publish.

### CONVENIENCES AROUND BLS SOC AND O*NET JOB CODES (See FIG. 4)

18. A Skills Architect 102 is able to use the user interface to recognize a job code they enter into a skill, and automatically associate higher-order job codes with that skill, so that they can complete their work quickly and without error.
19. A Skills Architect 102 is able to use the user interface to be able to search for skills not only by job code but by the short name associated with a BLS SOC or O*NET job code so that they can find relevant skills more easily.
20. A program team member 104 may wish for the expression of a collection they are using to contain job codes and the short names associated with those job codes, where available in the system, so that they can readily understand the contents of the collection.
21. A non-Skills Architect or public viewer (e.g., external user 106) of a skill may be able to use a user interface to see the job code and name for each job code associated with the skill.

### Import Skills

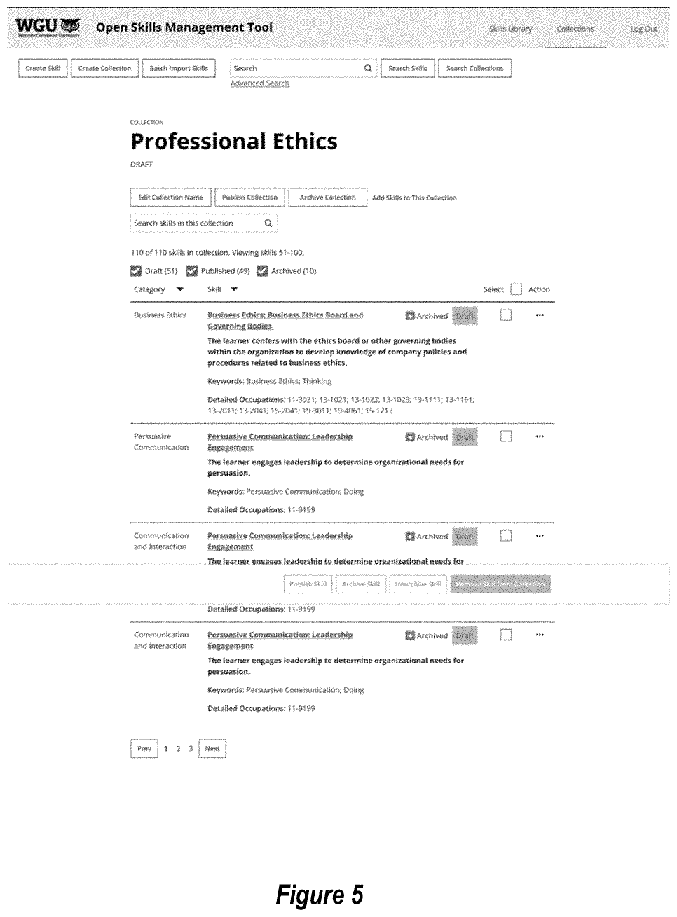

22. A Skills Architect 102 is able to use the user interface to batch import complete or partial skills into the system via CSV so that they can use or improve them later.
   » This creates new skills (in some embodiments); new skills start in “draft” status
23. A Skills Architect 102 is able to use the user interface to see (during import) skills that have potentially duplicate descriptions so that they can be led to produce fewer and better-aligned skills.
   Work with Collections (See FIGS. 5, 6, and 7)

To serve the program team and other consumers of skills, a Skills Architect 102 is able to create collections, add skills to and remove skills from them, search for and view them, archive and unarchive them, and make them available to others.

### CREATE COLLECTION (See FIG. 5)

24. A Skills Architect 102 is able to use the user interface to create a collection so that they can gather skills for use by a product team.

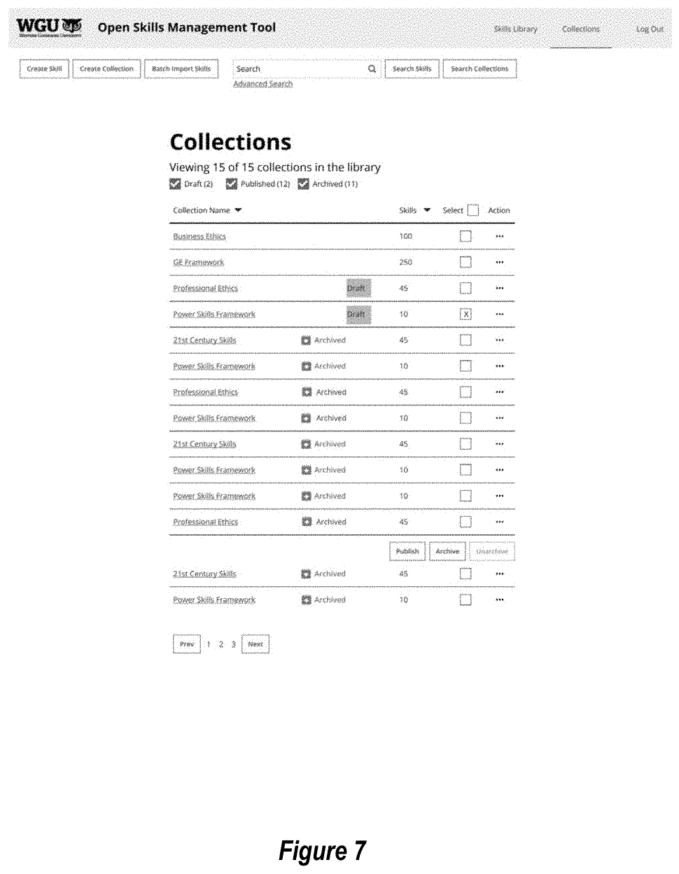

### SEARCH/READ COLLECTIONS (See FIG. 7)

25. A Skills Architect 102 is able to use the user interface to view the list of collections so that they can select one to operate on.
26. A Skills Architect 102 is able to use the user interface to search for a collection so that they can select one to operate on.
27. A Skills Architect 102 is able to use the user interface to search within a collection so that they can select a skill to inspect or edit.
28. A Skills Architect 102 is able to use the user interface to view the skills included in a collection so that they can understand its readiness for consumption.
29. A Skills Architect 102 is able to use the user interface to view a collection in the system via URL so that they can determine if it needs further editing or is ready to share.
30. A non-Skills Architect user is able to use a user interface to view the public view of a collection via URL so that they can make use of its contents.
31. A non-Skills Architect user is able to use a user interface to retrieve the contents of the public view of a collection in CSV format so that they can use its contents to do other work.
32. A non-Skills Architect user is able to use a user interface to retrieve the contents of the public view of a collection via URL in JSON-LD format so that they can use it in a system that operates on Credential Engine's CTDL-ASN standardized representation of skill data.

### Update Collection

33. A Skills Architect 102 is able to use the user interface to select one or more skills from a list, then include them in a collection, so they can be used in the work of the program team.
34. A Skills Architect 102 is able to use the user interface to include the skill they are viewing in a collection so it can be used in the program team's work.
35. A Skills Architect 102 is able to use the user interface to remove a skill from a collection, via the individual skill, so it will not interfere with the program team's work.
36. A Skills Architect 102 is able to use the user interface to remove a skill from a collection, via the list of skills included in the collection, so it will not interfere with the program team's work.
37. A Skills Architect 102 is able to use the user interface to be warned when they attempt to add a draft skill to a published collection so that they do not confuse the program team.

### Archive Collection

38. A Skills Architect 102 is able to use the user interface to archive a collection so no one uses it mistakenly.
39. A Skills Architect 102 is able to use the user interface to unarchive a collection so it may be used again.

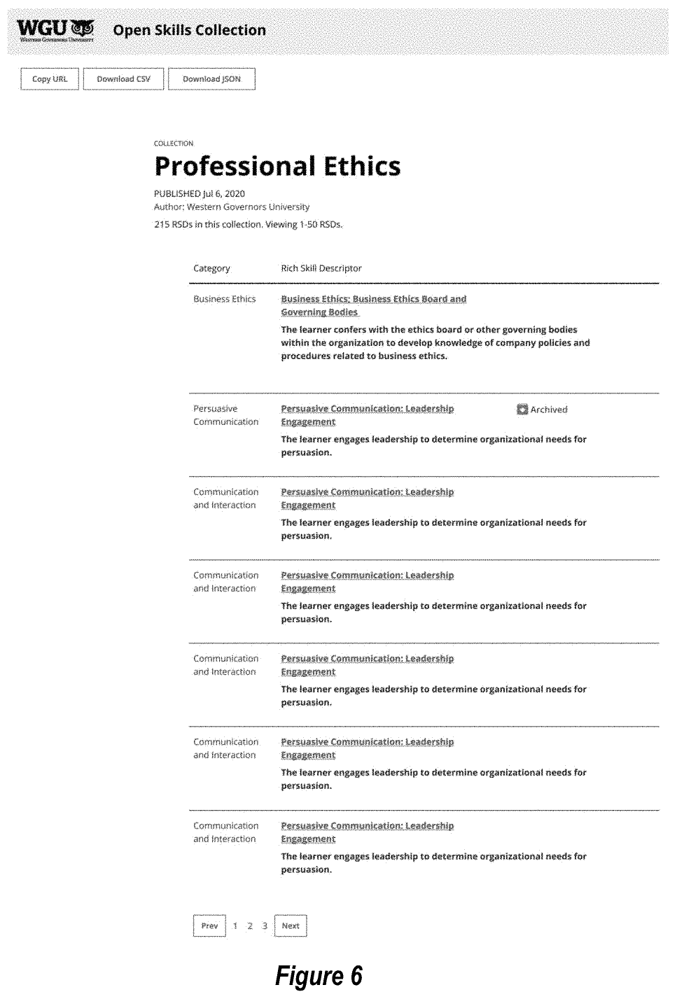

### Make a Collection Available to the Public (See FIGS. 5 and 6)

40. A Skills Architect 102 is able to use the user interface to make a collection available to the program team/public (by removing its “draft” status) so they can use it to inform their work.
41. A Skills Architect 102 is able to use the user interface to be warned when attempting to take a collection out of “draft” status if it has draft skills, so that they do not confuse the program team.
42. A Skills Architect 102 is able to use the user interface to be warned when attempting to take a collection out of “draft” status if it contains no skills, so that they do not confuse the program team.

### Understand a Collection (See FIG. 5)

43. A Skills Architect 102 is able to use the user interface to see the “draft” status of a collection so that they can have my attention brought to work in progress.

### Access

44. A Skills Architect 102 is able to use the user interface to be able to log into the system using the institution identity and access system, which can control who has access to authenticated use of the system, so that they can complete work in the system.

### Additional Details

Some embodiments will support the following general capabilities.

### Search for Skills

It is common for Skills Architects using the current skills spreadsheet to filter by one or more columns (keywords, job codes, etc.), then search for useful skills based on text fragments in skill statements and other strings. The search feature is able to accept and make use of all these data types.

### Publish Skills

A skill goes from unpublished to published merely by removing its “draft” status.

“Draft” status is purely a human decision (in some embodiments) but is intended to ensure that a skill is not merely complete in its strictly required parts but also complete enough to be useful to others.

When a skill is in “draft” status, it is not visible to the outside world at its canonical URL. When a skill's “draft” status is removed, the system makes it immediately available to the public.

The skill's canonical URL is subject to content negotiation. User agents (UAs) requesting HTML will receive a nicely formatted, human-readable HTML expression of the skill. UAs requesting JSON or JSON-LD will receive a standards-compliant JSON representation of the skill suitable for use in systems that understand CTDL-ASN.

### Publish Collections

A collection goes from unpublished to published merely by removing its “draft” status. Removing “draft” status is purely a human decision (in some embodiments) but is intended to denote that a collection is ready for others to use.

When a collection is in “draft” status, it is not visible to the outside world at its canonical URL. When a collection's “draft” status is removed, the system makes it immediately available to the public.

The collection's canonical URL is subject to content negotiation. UAs requesting HTML will receive a nicely formatted, human-readable HTML expression of all skills in the collection. UAs requesting JSON or JSON-LD will receive a standards-compliant JSON representation of the collection suitable for use in systems that understand CTDL-ASN.

The HTML representation of the collection also contains a control that allows the UA to obtain a CSV file containing the data for each skill in the collection.

### Allow Internal and External Access by Url

The system is available to authenticated users at a URL internal to the institution.

Skills and collections that have been made public are available to unauthenticated users at their canonical external URLs.

Skills and collections that have not yet been made public are available only to authenticated users at their canonical external URLs.

Skills and collections are also available to authenticated users within the system via specific internal URLs related to their canonical external URLs for convenience of directing system user attention to a specific skill or collection.

### Prevent Premature Publication of a Collection

A collection is useful when it contains a set of fully qualified, useful, related skills. Therefore, it is recommended that a collection not be made public (have its “draft” status removed) if it contains skills in “draft” status.

A user who attempts to remove “draft” status from a collection containing one or more skills with “draft” status can be warned—in some embodiments with the option to publish anyway, thereby removing the draft status from the indicated skills as well.

A user who attempts to add a draft skill to an already public collection may be warned—in some embodiments with the option to do so anyway, thereby removing the draft status from the indicated skill.

### Prevent Duplicates

Helping avoid duplicate (highly similar) contextualized skill statements is important during batch import of skills and nice to have during authoring of a skill. To a human a skill statement is possibly a duplicate, when to a computer it is merely similar. Thus, some embodiments implement a similarity (and/or distance) search that returns skills with the most similar skill statements, within some predetermined similarity threshold. In some embodiments, a similarity threshold may be set via trial.

### Track Changes

Some embodiments may explicitly version skills or collection. In other embodiments, the system does not explicitly version skills or collections. In such embodiments, however, it does keep an audit log of changes to a skill or a collection and expose it to internal users. This intends to allow users to recover from mistakes and unintended consequences, review edits, etc. It is up to the Skills Architect whether to create a new skill or collection when a substantive change is necessary.

### Keyword Association

Keywords will be used to group skills, rather than single categories. A keyword may be a word or a phrase (and can contain a space). Zero keywords may be associated with a skill, but a skill isn't easy to find and understand without at least one.

Help with Job Codes

Entering and segmenting BLS SOC and O*NET job codes in the current skills spreadsheet is arduous and error prone. The system understands these codes well enough to infer the higher-order codes when a more granular code is entered, so these codes can be available for searches. In some embodiments, the system displays job code short names in useful places for Skills Architects and program team members, as well as allow searches to make use of their text.

The system allows Skills Architects to enter other strings as job codes, so other job code systems might be captured in skills in a basic way.

### Link to Outside Data Sources

For some embodiments, it is sufficient for Skills Architects to record zero or more URLs, pointing to outside data sources, in an individual RSD. This is meant to be inexpensive and preserve optionality for later possible integrations with EMSI and other data sources.

### Be Visually Similar to Other Institution Tools

The appearance of the system, in some embodiments, is consistent with other institution tools and makes use of patterns found there wherever helpful.

### Open Source

In some embodiments, the system is shareable as an open source package. In some embodiments, this may be accomplished by providing:
Source code for the back end and front end of the system tool, Kotlin/Spring/Angular, made public via GitHub.
Deployment/infrastructure notes and details so open source users can deploy the tool and use it, made public via GitHub.
Deployment/infrastructure work so the institution can deploy the tool to its existing production environments, proprietary.

### Be White-Label Ready

A lightweight way to change the appearance of the tool (such as a configuration file containing colors, URLs of logo assets, etc.) may govern the branded appearance of the system. This will allow the system deployed at the institution to appear to be a sibling of other the institution tools while being deployable by others.

### MV Views, Variants, and Modules

Following are system views that may be included in various embodiments, including their capabilities and related data.

### Skills Lists

1. Library empty (skills list empty)
   » Local capabilities
      [symbol] Create skill (revealed in empty state)
   » Common capabilities
      [symbol] Create skill
      [symbol] Create collection
      [symbol] Search for skills/collections
      [symbol] View library of skills/collections
      [symbol] Batch import skills via CSV
      » Data: empty state message and action
   » Notes
      [symbol] It should be a lightweight empty state as it won't be empty for long
2. Library populated (skills list)
   » Local capabilities
      [symbol] View skill from list
      [symbol] Multi-select skills for association with a collection
   » Common capabilities
      [symbol] Create skill
      [symbol] Create collection
      [symbol] Search for skills/collections
      [symbol] View library of skills/collections
      [symbol] Batch import skills via CSV
» Data: skills as list items
Notes
   [symbol] Likely paginated
   [symbol] This may be the “home” page for system
   [symbol] Any skills display, skills form, etc. will be informed by the RSD schema
3. List of skills, search results (skills list)
   » Local capabilities
      [symbol] Revise search
      [symbol] View skill from list
      [symbol] Multi-select skills for collection
   » Common capabilities
      [symbol] Create skill
      [symbol] Create collection
      [symbol] Search for skills/collections
      [symbol] View library of skills/collections
      [symbol] Batch import skills via CSV
   » Data: skills as list items
   » Success: list
   » Errors: empty list, what was wrong with the query
   » Notes
      [symbol] Likely paginated
4. collection, empty
   » Local capabilities
      [symbol] Archive/unarchive this collection
      [symbol] Edit collection name
      [symbol] Publish collection (remove “draft” status)
   » Common capabilities
      [symbol] Create skill
      [symbol] Create collection
      [symbol] Search for skills/collections
      [symbol] View library of skills/collections
      [symbol] Batch import skills via CSV
   » Data
      [symbol] Empty state for collection with no skills yet
      [symbol] “Draft” status
      [symbol] Archived state (or not)
      [symbol] Canonical URL
   » Notes
      [symbol] Prevent publication of an empty collection (warn when removing “draft” status if collection is empty)
      [symbol] Addressable via list in system and directly via URL
5. collection, populated
   » Local capabilities
      [symbol] Revise search
      [symbol] Search within this collection
      [symbol] View a skill from the list
      [symbol] Multi-select skills for removal from collection
      [symbol] Remove selected skills from a collection
      [symbol] Archive/unarchive this collection
      [symbol] Edit collection name
      [symbol] Publish collection (remove “draft” status)
   » Common capabilities
      [symbol] Create skill
      [symbol] Create collection
      [symbol] Search for skills/collections
      [symbol] View library of skills/collections
      [symbol] Batch import skills via CSV
   » Data
      [symbol] Collection name
      [symbol] Skills as list items
      [symbol] Draft status (or not)
      [symbol] Archived state (or not)
      [symbol] Canonical URL
   » Notes
      [symbol] Prevent publication of a collection containing draft skills (warn when removing “draft” status if draft skills are present in the collection)
      [symbol] Prevent publication of an empty collection (warn when removing “draft” status if collection is empty)
      [symbol] Likely paginated
      [symbol] Addressable via list in system and directly via URL

### Single Skill

6. Skill
   » Local capabilities
      [symbol] Edit
      [symbol] Clone
      [symbol] Remove “draft” status (publish)
      [symbol] Archive/unarchive
      [symbol] Add to a collection
      [symbol] Remove from a collection
      [symbol] Check for similar skill statements
   » Common capabilities
      [symbol] Create skill
      [symbol] Create collection
      [symbol] Search for skills/collections
      [symbol] View library of skills/collections
      [symbol] Batch import skills via CSV
   » Data
      [symbol] Everything in a fully qualified skill
      [symbol] Edit history—list of edits in reverse chronological order up to the current skill contents
      [symbol] Canonical URL
      [symbol] Draft status (or not)
      [symbol] Archived state (or not)
      [symbol] Collections in which the skill is used
   » Notes
      [symbol] Can be accessed via list in system, directly in system via system skill URL, and directly via public canonical URL if published
      [symbol] Ideally, user can directly edit from here rather than having a separate edit view
      [symbol] Note: The exact manner of exposing and handling potential duplicates will be designed in a later phase
7. New Skill Form
   » Capabilities
      [symbol] Save
      [symbol] Cancel
      [symbol] Check for similar skill statements
   » Data: empty, but pre-populate “Creator” and auto-generate “Skill ID/Canonical URL”
   » Success:
      [symbol] Saved skill, with “draft” status
      [symbol] Show prior view with notice that skill was saved? Or show a new skill?
   » Errors: new skill form required fields not populated
   » Note: The exact manner of exposing and handling potential duplicates will be designed in a later phase

### List of Collections

8. List of collections, empty
   » Common capabilities
      [symbol] Create skill
      [symbol] Create collection
      [symbol] Search for skills/collections
      [symbol] View library of skills/collections
      [symbol] Batch import skills via CSV
   » Data: empty state message featuring create collection action
9. List of collections, populated
   » Local capabilities
      [symbol] Select collection
      [symbol] View collection
      [symbol] Archive/unarchive collection
      [symbol] Remove “draft” status of collection
   » Common capabilities
      [symbol] Create skill
      [symbol] Create collection
      [symbol] Search for skills/collections
      [symbol] View library of skills/collections
      [symbol] Batch import skills via CSV
   » Data: collections as list items, containing
      [symbol] Name
      [symbol] Number of skills
      [symbol] Archived state
      [symbol] “Draft” status
      [symbol] Possibly: frequent keywords
      [symbol] Possibly: publication date
10. List of collections, search results (a form of collections list)
   » Local capabilities
      [symbol] Select collection
      [symbol] View collection
      [symbol] Remove “draft” status of collection
      [symbol] Archive/unarchive
   » Common capabilities
      [symbol] Create skill
      [symbol] Create collection
      [symbol] Search for skills/collections
      [symbol] View library of skills/collections
      [symbol] Batch import skills via CSV
   » Data: collections as list items
   » Success: list of collections
   » Errors: empty list, what was wrong with the query 11. New collection form
   » Capabilities: save, cancel
   » Data: none, pre-populate “Creator” and “Canonical URL” D Success
      [symbol] Saved collection
      [symbol] Show collection empty state?
   » Errors: new collection form not populated enough to save; must have title

### Public Views

12. Public view of skill
   » Capabilities
      [symbol] Content negotiation—can get HTML or JSON-LD
      [symbol] Download as CSV
   » Data
      [symbol] All elements in the RSD schema
      [symbol] Canonical URL
      [symbol] Archived state
         Date archived
      [symbol] “Draft” status (if authenticated)
   » Errors
      [symbol] URL does not point to a skill (404)
      [symbol] URL requires authentication to view (401?)
13. Public view of collection
   » Capabilities
      [symbol] Content negotiation—can get HTML or JSON-LD
      [symbol] Download as CSV
   » Data
      [symbol] Collection name
      [symbol] Canonical URL
      [symbol] Archived state
      [symbol] “Draft” status (if authenticated)
      [symbol] Stack of skills entries, including for each skill:
         All elements in the RSD schema
         Canonical URL
         Archive status
         Draft status (if authenticated)
   » Errors
      [symbol] URL does not point to a collection (404)
[symbol] URL requires authentication to view (401?)

### Special Views

14. Batch import process
   » Capabilities
      [symbol] Batch upload process
         Get template
         Upload data
         Check field mapping
         Address parse errors, including potential duplicates (skill statement very similar to other skills in library)
         Accept new records
   » Data: none to start
   » Success: skills list showing one or more imported records
   » Errors: parse errors, records not imported and their details, other errors common to parsing CSV and batch import
   » Note: the exact manner of exposing and handling potential duplicates will be designed in a later phase MODULES

Embodiments may incorporate the following user interface modules in various configurations:
Skill display, skill form (ideal if one can be the other, editable in place)
   » Includes skill edit history
Lists
   » List view of skills
      [symbol] Skill as a list item
   » List view of collections
      [symbol] Collection as a list item
   » Single/multi-select of list items
Search controls for skills or collections
Consistent location and appearance of universal capabilities (create skill, create collection, search for skills/collections, batch import skills via CSV)
Confirmation dialogs for archive/unarchive or publish and warnings around same
Status for archived/unarchived or draft/published
Pagination
Keyword suggestion (add similar items or select from a list)

### ADDITIONAL EMBODIMENTS

Embodiments may implement one or more of the following features:

### Conveniences for Improving a Skill

Embodiments may include guidance in a user interface for Skills Architects adding certifications to a skill so that one can be sure the correct ones are included.
Embodiments may include guidance in a user interface for Skills Architects adding standards to a skill so that one can be sure the correct ones are included.
Embodiments may include guidance in a user interface for Skills Architects adding a keyword to a skill so that one can be sure the correct one is used.
Embodiments may include guidance in a user interface for Skills Architects finding skills that are missing pertinent information so that they can prepare them for use by others.
   Conveniences for Working with a Collection
A Skills Architect 102 is able to use the user interface to begin establishing a new collection by first selecting one or more skills to include so that they can more conveniently start a collection from search results.
A Skills Architect 102 is able to use the user interface to make a clone of a collection so that they can edit the collection.
A Skills Architect 102 is able to use the user interface to give a collection a description to be more informative to the program team.
A Skills Architect 102 is able to use the user interface to give a collection keywords to make finding collections easier.
A Skills Architect 102 is able to use the user interface to view edit history for a collection so that they can determine where problems originated.

### Batch Editing

is able to use the user interface to update the tagging or keywords of multiple selected skills at one time so that they can more rapidly and accurately associate the selected skills with the same job code, standard, etc.
   Working with Keywords

To facilitate keyword management (merge them, rename them outside of skills, etc.) the keywords can be implemented as objects unto themselves.
A Skills Architect 102 is able to use the user interface to create a new keyword so that they can better organize and segment the skills library and collections.
A Skills Architect 102 is able to use the user interface to search the list of used keywords so that they can find one or more to operate on to improve skill findability.
A Skills Architect 102 is able to use the user interface to see keywords used so that they can select keywords to edit.
A Skills Architect 102 is able to use the user interface to edit a keyword so that they can correct an error or adapt to emerging vocational terminology.
A Skills Architect 102 is able to use the user interface to assign multiple keywords to a skill so the skill has more context.

### Versioning

Explicit versioning of skills
Explicit versioning of collections

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

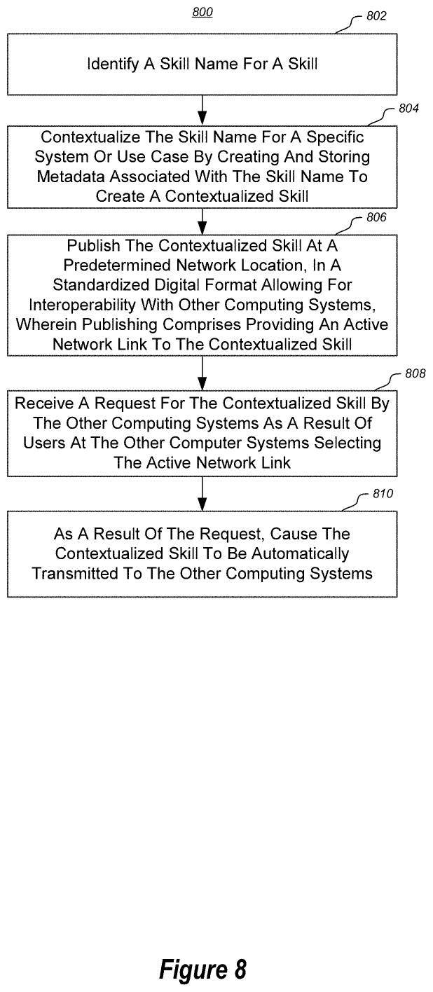

Referring now to FIG. 8, a method 800 is illustrated. The method 800 includes acts for transmitting digital definitions of skills at a computing system to allow the digital definitions of skills to be interoperable with other computing systems. The method 800 includes identifying a skill name for a skill (802).

The method 800 further includes contextualizing the skill name for a specific system or use case by creating and storing metadata associated with the skill name (804).

The method 800 further includes publishing the contextualized skill at a predetermined network location, in a standardized digital format allowing for interoperability with other computing systems, wherein publishing comprises providing an active network link to the contextualized skill (806).

The method 800 further includes receiving a request for the contextualized skill by the other computing systems as a result of users at the other computer systems selecting the active network link (808).

The method 800 further includes as a result of the request, causing the contextualized skill to be automatically transmitted to the other computing systems (810).

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of transmitting digital definitions of skills at a computing system to allow the digital definitions skills to be interoperable with other computing systems, the method comprising:
identifying a skill name for a skill;
contextualizing the skill name for a specific system or use case by creating and storing metadata associated with the skill name to create a contextualized skill;
publishing the contextualized skill at a predetermined network location, in a standardized digital format allowing for interoperability with other computing systems, wherein publishing comprises providing an active network link to the contextualized skill.

2. The method of claim 1, wherein contextualizing the skill name comprises associating the skill name in a data store with a skill statement expressing information about who the skill applies to, the nature of the skill itself, and the context in which it is applied; a category identifying a term that can be used to group multiple skills.

3. The method of claim 1, wherein contextualizing the skill name comprises associating the skill name in a data store with a category identifying a term that can be used to group multiple skills.

4. The method of claim 1, wherein contextualizing the skill name comprises associating the skill name in a data store with one or more keywords comprising terms.

5. The method of claim 1, wherein contextualizing the skill name comprises associating the skill name in a data store with information identifying an author.

6. The method of claim 1, wherein contextualizing the skill name comprises associating the skill name in a data store with information identifying associated collections.

7. The method of claim 1, wherein contextualizing the skill name comprises associating the skill name in a data store with information identifying numeric job codes from BLS or O*NET.

8. The method of claim 1, wherein contextualizing the skill name comprises associating the skill name in a data store with one or more standards from subject matter experts.

9. The method of claim 1, wherein contextualizing the skill name comprises associating the skill name in a data store with one or more certifications.

10. The method of claim 1, wherein contextualizing the skill name comprises associating the skill name in a data store with one or more employers.

11. The method of claim 1, wherein contextualizing the skill name comprises associating the skill name in a data store with one or more alignments comprising one or more URIs identifying similar skills.

12. The method of claim 1, further comprising adding the contextualized skill to a collection and publishing a URL to the collection.

13. The method of claim 1, further comprising archiving the contextualized skill.
